(19) United States
(12) Patent Application Publication
(10) Pub. No.: US 2025/0051644 A1
(43) Pub. Date: Feb. 13, 2025

(54) PYROLYTIC CARBON FOR PROTECTING SOIL MACRO-AND MEGA-FAUNA

(71) Applicant: BASF SE, Ludwigshafen am Rhein (DE)

(72) Inventors: Dieter FLICK, Ludwigshafen am Rhein (DE); Alexander WISSEMEIER, Ludwigshafen am Rhein (DE)

(21) Appl. No.: 18/721,212

(22) PCT Filed: Dec. 14, 2022
(86) PCT No.: PCT/EP2022/085806

§ 371 Date: Jun. 18, 2024

(30) Foreign Application Priority Data
Dec. 22, 2021 (EP) 21216766.2

(51) Int. Cl. C09K 17/04; A01N 61/00; A01P 15/00

(52) U.S. Cl. CPC C09K 17/04; A01N 61/00; A01P 15/00; C01P 2006/10; C01P 2006/12

(57) ABSTRACT

The present invention comprises the use of a hydrophobic pyrolytic carbon having a density of 1 to 3 g/cc, a carbon content of 95 to 100 weight-% and an ash content of 0.001 to 5 weight-%, wherein 85 weight-% of the carbon is not-functionalized, as protective agent for macro- and megafauna.

The present invention comprises the use of a hydrophobic pyrolytic carbon having a density of 1 to 3 g/cc, a carbon content of 95 to 100 weight-% and an ash content of 0.001 to 5 weight-%, wherein 85 weight-% of the carbon is not-functionalized, as protective agent for macro- and megafauna.

Soil organisms are divided into microorganisms, mesofauna, macrofauna and megafauna according to their size. The macrofauna includes soil animals from 2 to 20 mm and the megafauna soil animals over 20 mm. Typical animals of the macrofauna are centipedes, enchytraeids, weavers, wood birds or larvae of flying insects. Earthworms are counted by size to both macrofauna and megafauna.

Earthworms play a central role in soil biology and ecology. They are responsible for the mixing of plant residues into the soil, the mixing of organic and mineral substances as well as the formation of crumbs by intestinal passage, the stabilization of soil aggregates by mucus, forming biopores, increasing the rate of infiltration, increasing the space available to roots for nutrient absorption, decomposition of organic matter, and phytosanitary action (Handbuch des Bodenschutzes. Bodenökologie und-belastung. Vorbeugende und abwehrende Schutzmaßnmahmen. 2. Auflage—ecomed Verlag, Landsberg/Lech, 795 p).

In addition, earthworms are also an important part of ecosystems, as they are the food source for other animals such as amphibian or birds.

Because of their importance as an indicator of soil health, earthworms are part of the fixed standard of any environmental safety test of new approvals of agrochemicals (see REACH registration.)

Soil is a very important production factor for farmers and protecting the macro- and megafauna in the soil is one of the central task for farmers. Earthworm populations are exposed to various threads from agricultural practice. This includes soil compaction, intensive tillage, one-sided crop rotations, as well as mineral and organic pollutants, or pesticides as additives to soils.

For example, tillage like plowing disturbs and reduces soil fauna as e. g. ventilating earthworm tunnels are destroyed, and the earthworm habitat is negatively affected.

To develop a positive soil structure without tillage, numerous and as active as possible earthworms are important. On land that has been cultivated without plowing for many years, the so-called bioturbation of earthworms is also responsible for distributing crop residues, pesticide residues and nutrients from the soil surface into the topsoil.

However, earthworms are e.g., not popular on greens of golf courses because their casting activities. Attraction of earthworms around the greens would therefore diminish this problem. On the other hand, it is very attractive to increase earthworm abundance in agricultural fields.

WO 2021/122503 and WO 2021/122500 disclose granular pyrolytic carbon and carbon black as soil conditioner to reduce erosion by wind and reduces moisture loss and shows good water infiltration. The application of both pyrolytic carbon and carbon black increased the formation of plant biomass. It was shown that neither granular pyrolytic carbon nor carbon black caused any CO2 evolution and thus, these soil conditioners cannot be recognized as food for soil organisms. Thus, an influence of pyrolytic carbon on the soil organisms was neither studies nor predicted in these WO publications.

U.S. Pat. No. 2,877,599 discloses that carbon black having a high volume for its weight could be incorporated in the soil to darken the soil and improve heating from solar radiation and absorption and retention of water. U.S. Pat. No. 2,877,599 discloses a soil conditioner in compact pellet form wherein the carbon black comprises 5 to 40%, preferably 10 to 20%, gypsum up to 50%, binder up to 1% and organic fibrous material up to 95%, e. g. sludge from sewage processing plants, waste liquor from paper mills or humus. The soil conditioner would be spread on the soil in quantity ranging from 200 pounds (90 kg) to two tons per acre (0.405 ha). A disclosure of an effect on the macro-fauna is not made.

U.S. Pat. No. 3,345,773 discloses the use of carbonaceous solids having a diameter of 0.08 inch to 0.5 inch as mulch to promote germination and growth of plants by warming the soil, preventing crusting of the soil and by retaining moisture in the soil. Various useful carbon solids are described, for example coal, e. g. lignites, anthracites and bitumen coals and coke derived from coals and from petroleum. Preferably, the carbonaceous solids are mixed with water impermeable material to provide a water barrier. A disclosure of an effect on the macro-fauna is not made.

U.S. Pat. No. 3,341,318 discloses a mulch composition containing lignin sulfonate compositions, a byproduct of the paper industry, carbon black and water. These mulch compositions provide increased soil temperatures, thus assuring better germination of crop seeds and earlier emergence and earlier maturity, conserve soil moisture, reduce windblown soil loss, spray easily without clogging applicator nozzles and are non-corrosive to application equipment. A disclosure of an effect on the macro-fauna is not made.

JP 9310068 concerns a soil conditioner comprising carbon material having a high specific surface area of 30-500 m/g composed of combustion residues of waste rubber products. A disclosure of an effect on the macro-fauna is not made.

Carbon sources of unknown composition i. e. carbon containing waste material are potentially hazardous as they may contain components that are environmentally harmful or toxic. Environment protective regulations require that soil additives e. g. soil conditioners are safe and do not add pollutive agents to the soil.

In view of the unknown components using waste material, WO 2012/15313 discloses a system for a manufacturing of a soil conditioner wherein a gaseous hydrocarbon source is fed to plasma cracking unit, and the produced plasma carbon is fed to a unit wherein the plasma carbon is mixed with a substrate, to produce a carbon enriched soil conditioner. The substrate to be mixed with carbon can be different soil types like sand, clay or organic waste. A disclosure of an effect on the macro-fauna is not made.

Recently, biochar is disclosed as a promising soil conditioner in view of humus depletion, climate change and waste organic management.

There are mainly three benefits claimed for biochar: Soil enhancement, N2O reduction and C-Sequestration. The large surface areas of biochar could lead to a long-term water storage, the functional groups could bind nutrient, and the black color could improve soil warming. The change in physical habitats in the spoil could lead to alterations of microbial community and suppress N2O emissions. The polycyclic aromatics of the biochar degrade more slowly than the original biomass being a carbon sink.

In view of macro-fauna, only a few studies were conducted up to now. Most of these studies focus on earthworms. The effects of biochar on soil flora and fauna are dependent on the quality and property of the biochar, especially on the source material and the production process, and on the chemical and physical properties of the field.

Biochar made by a low temperature process seems to increase the activity of earthworms, whereas biochar made by a high temperature process seems to decrease the activity. An increase of the pH of the soil from 5 to 7.5 by the application of biochar also seems to increase the earthworm activity, whereas an application of biochar with a lower pH value reduces the activity. Biochar from poultry manure or sugar beets seem to reduce the earthworm activity, whereas biochar from pinewood or from peanut shells increased the earthworm activity.

Thus, clear and generally valid statements on the effect on soil biology are therefore not possible (“Chancen und Risiken des Einsatzes von Biokohle und anderer “veränderter” Biomasse als Bodenhilfsstoffe oder für die C-Sequestrierung in Böden “, Chapter 2.8 “Kurz-und langfristige Wirkungen der Biokohle im Boden, auf Bodenorganismen und Pflanzen”, Umweltbundeamt, 2016).

Pyrolysis biochar can rarely be used by microorganisms as a source of energy or nutrients and will stay in the soil, but biochar by hydrothermal carbonization can be used due to their higher proportion of easily degradable carbon sources and will end up as unwanted CO2 source.

In addition, the conversion process of biomass into pyrolysis biochar must also be critically evaluated with regard to the pollutant content in the product (especially PAH).

US 2013/312472 discloses a composition comprising pyrolyzed biomass that is utilized for soil amendment. It is mentioned in US 2013/312472 that owing to the high porosity, the biochar accumulates nutrients and microorganisms, such that the plants grow even in highly porous soils. U.S. Pat. No. 8,361,186 discloses that biomass material can be pyrolyzed and such granular pyrolytic carbon can be used as a soil conditioner.

US 2019/002764 also disclose the use of pyrolyzed and surface-oxygenated biochar with optimized hydrophilicity as a soil conditioning substrate.

U.S. Pat. No. 9,809,502 discloses a treatment of biochar and that the treated biochar has an impact on plant growth and/or soil health, as the biochar provides a time release effect or steady flow of infused beneficial additives to the root zones of the plants and also can improve and provide a more beneficial environment for microbes. The treated biochar provides with its higher hydrophilic character an improved capacity to adsorb and desorb beneficial additives such as ammonia and ammonium ions. D1 discloses a benefit to microbes that fit and colonize in the pores of treated biochar. The disclosed biochar has a solid particle density of 0.2 to 1.2 g/cm3, a surface area of 200 to 600 m2/g, an ash content of 0.1 to 5 wt.-% and a hydrophilicity of 0 to 4 MED. The carbon content is at least 55 wt.-%.

US 2016/137924 discloses char compositions as soil amending agent. The char-based composition has a density of less than 1 g/ml, a carbon content of 10 to 99 wt.-% and an ash content of 0.15 to 1.45 wt.-%. It is disclosed that functionalizing of the char is beneficial.

Another characteristic of biochar is the cation exchange capacity (CEC) of about 1 to 30 cmol/kg. The CEC of biochar is to a large extent a function of the production temperature, the higher the production temperature the lower the CEC. The range of CEC in arable soils in Central Europe is about 3 to 25 cmol/kg.

None of these documents include a disclosure of an effect on the macro-fauna.

It is an object of the present invention to provide a protective agent for soil macro- and megafauna and a process for protecting soil macro- and mesofauna.

It is a further object of the present invention to balance negative effects on the soil macro- and megafauna by soil tillage like plowing, milling, or refining the field or by applying crop protection agents or fertilizers as e.g., boric acid.

It is a further object of the invention to control the density of earthworms by attraction.

The present invention provides a protective agent for soil macro- and mesofauna containing hydrophobic pyrolytic carbon composition having a density of 1 to 3 g/cc, a carbon content of 95 to 100 weight-% and an ash content of 0.001 to 5 weight-%, wherein 85 weight-% of the carbon is not-functionalized.

Surprisingly, a positive effect of such hydrophobic pyrolytic carbon could be found, although this carbon is—in contrast to biochar—almost inert, being denser, having less cation exchange capacity and being hydrophobic. In contracts to biochar, this hydrophobic pyrolytic carbon is neither an organic nor an inorganic nutrition for macro- and mega-fauna.

The present invention provides a method for protecting soil macro-fauna which comprises applying hydrophobic pyrolytic carbon composition having a density of 1 to 3 g/cc, a carbon content of 95 to 100 weight-% and an ash content of 0.001 to 5 weight-%, wherein 85 weight-% of the carbon is not-functionalized on agricultural fields in quantity ranging from 0.5 to 500 tons per ha and working that pyrolytic carbon into the topsoil.

The present invention also provides a method for controlling the presence of earthworms which comprises applying hydrophobic pyrolytic carbon having a density of 1.6 to 2.3 g/cc, a carbon content of 95 to 100 weight-%, wherein 90 weight-% of the carbon is not-functionalized on that part of the area where presence of earthworm is desirable and leaving the other part of the area where the presence of earthworm is not desirable un-treated.

### Macro- and Megafauna

The present protective agent is preferably used to protect macro- and megafauna, more preferably to protect soil animals from 1 to 50 mm, preferably from 2 to 30 mm. Preferably, earthworms, centipedes, enchytraeids, weavers, wood birds or larvae of flying insects are protected, in particular earthworms.

### Pyrolytic Carbon

The word “pyrolytic carbon” covers a solid carbon composition produced from pyrolysis of hydrocarbons, preferably light hydrocarbons like methane, in absence of oxygen (see for example Muradov, Nazim. “Low to near-zero CO2 production of hydrogen from fossil fuels: Status and perspectives.” International Journal of Hydrogen Energy 42.20 (2017): 14058-14088). Typically, the decomposition of light hydrocarbons, especially methane, is done by a plasma process, by a liquid metal process, by a microwave process, by a catalytic or un-catalytic process, e.g., in an electric heated fixed or moving bed reactor.

### Granular Pyrolytic Carbon

The pyrolytic carbon can be produced by decomposition of gaseous hydrocarbon compounds, preferably the decomposition of methane, and carbon deposition on suitable underlying substrates (carbon materials, metals, ceramics and a mixture thereof), preferably at temperatures ranging from 1000 to 2500 K and at pressures ranging from 0.5-10000 kPa (abs). The substrate can either be porous or non-porous and can be either be a support substrate in the reactor (a pre-installed part) or a granular and powderish material. In case of using a support containing catalytic active metals, such metals are preferred that have positive or no interaction to the seed germination and plant growth and can remain in the soil like iron. The preferred substrate is a carbon-containing substrate, for example pyrolytic carbon, which means carbon derived from oxygen-free thermal decomposition of hydrocarbons in presence of a carboneous deposition substrate at temperatures >1000° C. The particle size of a preferred support substrate is in the range of 0.3 to 15 mm, preferably 0.5 to 10 mm, more preferably 1 to 8 mm, more preferably 3 to 8 mm. The decomposition can either be realized as fixed bed, moving bed, fluidized bed or entrained flow. The production of granular pyrolytic carbon is not limited to a specific energy supply, fossil-fired, solar-thermal, electrically heated, micro-wave-driven, plasma-driven, or liquid metal production reactors are possible.

A wide range of microstructures, e. g. isotropic, lamellar, substrate-nucleated and a varied content of remaining hydrogen, can occur in pyrolytic carbons, depending on the deposition conditions (pressure, temperature, type, concentration and flow rate of the source gas, surface area of the underlying substrate, etc.).

Typically, the density of the granular pyrolytic carbon is in the range of 1.5 to 2.5 g/cc, 1.6 to 2.3 g/cc, preferably 1.8 to 2.2 g/cc, more preferably 1.9 to 2.15 g/cc (real density in xylene, ISO 8004). Typically, the bulk density of the granular pyrolytic carbon is in the range of 0.5 to 1.5 g/cc, preferably 0.6 to 1.3 g/cc, more preferably 0.7 to 1.1 g/cc.

Typically, the ash content of the granular pyrolytic carbon composition is in the range of 0.001 to 1 weight-% of the composition, preferably 0.005 to 0.5 weight-%, even more preferably 0.01 to 0.3 weight-%, even more preferably 0.01 to 0.2 weight-%.

Typically, the carbon content of the granular pyrolytic carbon composition is in the range of 95 to 100 weight-% of the composition, preferably 98 to 100 weight-%, more preferably 99 to 100 weight-%, even more preferably 99.5 to 100 weight-%, even more 99.75 to 100 weight-%, even more 99.9 to 100 weight-%. Typically, the impurities of the granular pyrolytic carbon are: S in the range of 0 to 1 weight-%, preferably 0 to 0.5 weight-%, more preferably 0 to 0.1 weight-%. Fe in the range of 0 to 1000 ppm, preferably 0 to 500 ppm, Ni in the range of 0 to 250 ppm, preferably 0 to 100 ppm, V in the range of 0 to 450 ppm, preferably 0 to 250 ppm, more preferably 0 to 100 ppm. Na in the range of 0 to 200 ppm, preferably 0 to 100 ppm. Oxygen is in the range of 0 to 100 ppm, preferably below the detection limit.

Typically, 85 weight-% of the carbon of the granular pyrolytic carbon composition is not-functionalized, preferably 90 weight-% of the carbon is not-functionalized, preferably 95 weight-% of the carbon is not-functionalized, preferably 98 weight-% of the carbon is not-functionalized, preferably 99 weight-% of the carbon is not-functionalized, preferably 99.5 weight-% of the carbon is not-functionalized, wherein carbon functionalization refers to a reaction in which a carbon-carbon bond is broken and replaced by a carbon-X bond (where X is usually hydrogen, oxygen, sulfur, phosphorus, nitrogen, halogens, and/or metals).

Typically, the cation exchange capacity (CEC) of granular pyrolytic carbon is about 0.01 to 1.5 cmol/kg, preferably of about 0.02 to 1 cmol/kg, preferably 0.025 to 0.75 cmol/kg, preferably 0.05 to 0.5 cmol/kg.

Typically, the carbon content of the granular pyrolytic carbon that is not-functionalized is in the range of 85 to 100 weight-%, preferably of 90 to 100 weight-%, preferably 95 to 100 weight-%, more preferably 98 to 100 weight-%, even more preferably 99 to 100 weight-%, even more 99.75 to 100 weight-%.

Typically, the particle size of the granular pyrolytic carbon directly resulting of the decomposition of gaseous hydrocarbon compounds is in the range of 0.3 mm (d10) to 8 mm (d90), preferably 0.5 mm (d10) to 5 mm (d90), more preferably 1 mm (d10) to 4 mm (d90).

This particle size is of the same size as fine gravel (typically 2 to 6 mm) or coarse sand (typically 0.5 to 2 mm).

Optionally, the granular pyrolytic carbon directly resulting of the decomposition of gaseous hydrocarbon compounds can be classified to a desired particle size or a desired particle size distribution if needed for specific agricultural applications. Multi-surface classifiers are commonly used for such kind of separation/classifying processes.

Typically, the crystal size (XRD) of the granular pyrolytic carbon is in the range of 20 to 60 Å, preferably 30 to 50 Å, (XRD, ISO 20203).

Typically, the porosity of the granular pyrolytic carbon granule is between 0% to 15%, preferably 0.2% to 10%, most preferably 0.2% to 5% (Hg porosimetry, DIN66133).

Typically, the specific surface area of the granular pyrolytic carbon measured by Hg porosimetry (DIN66133) is in the range of 0.001 to 10 m2/g, preferably 0.001 to 5 m2/g, more preferably 0.01 to 2 m2/g, even more preferably 0.05 to 2 m2/g.

The granular pyrolytic carbon is a hydrophobic material with a preferred contact angle of water droplets of greater than 90°, more preferably than 100°, even more preferably greater than 105° as determined with the sessile droplet method (Bachmann, J. et al. (2000), Modified sessile drop method for assessing initial soil-water contact angle of sandy soil. Soil Science Society of America Journal 64, 564-567). The granular pyrolytic carbon is a hydrophobic material with a preferred contact angle of water droplets in the range of ≥90° to ≤180°, preferably in the range of 100° to 170°, preferably in the range of 105° to 160°.

Typically, the granular pyrolytic carbon produced by decomposition of gaseous hydrocarbon compounds and carbon deposition on suitable underlying substrates does not tend to form dust.

Preferably, the granular pyrolytic carbon produced by decomposition of gaseous hydrocarbon compounds and carbon deposition on suitable underlying substrates can directly be used as a protective agent for soil macro-fauna. Preferably, there is no need for any pelleting step. Preferably, there is no need to add any binder, filler etc.

### Carbon Black

Carbon black is well known in the state of the art and e. g. described in Ullmann, Encyclopedia of Industrial Chemistry or in Kirk-Othmer Encyclopedia of Chemical Technology. The carbon black is typically characterized in ASTM classifications.

Carbon black is a commercial form of aggregates of carbon particles. Carbon black composition typically contains more than 95% pure carbon with minimal quantities of oxygen, hydrogen and nitrogen. In the manufacturing process, carbon black particles are formed that range from 10 nm to approximately 500 nm in size. These fuse into chain-like aggregates, which define the structure of individual carbon black grades.

The carbon content of the carbon black composition is preferably 80 to 99.8 weight-%, more preferred 85 to 99.5 weight-%, even more preferred 90 to 99.5 weight-%, even more preferred 95 to 99.5 weight-%. Typically, the impurities of the carbon black are: S in the range of 0 to 2 weight-%, preferably 0 to 1 weight-%, more preferably 0 to 0.5 weight-%. H2 in the range of 0 to 10 weight-%, preferably 0 to 5 weight-%, more preferably 0 to 2 weight-%, more preferably 0 to 1 weight-%. Oxygen in the range of 0 to 3 weight-%, preferably 0 to 2 weight-%, preferably 0 to 1.5 weight-%, more preferably 0 to 1 weight-%, more preferably 0 to 0.5 weight-%. N in the range of 0 to 5 weight-%, preferably 0 to 3 weight-%, more preferably 0 to 2 weight-%, more preferably 0 to 1 weight-%.

Typically, 85 weight-% of the carbon of the carbon black composition is not-functionalized, preferably 90 weight-% of the carbon of the carbon black is not-functionalized, preferably 95 weight-% of the carbon is not-functionalized, preferably 96 weight-% of the carbon is not-functionalized, preferably 97 weight-% of the carbon is not-functionalized, preferably 98 weight-% of the carbon is not-functionalized, wherein carbon functionalization refers to a reaction in which a carbon-carbon bond is broken and replaced by a carbon-X bond (where X is usually hydrogen, oxygen, sulfur, phosphorus, nitrogen, halogens, and/or metals).

Typically, the carbon content of the carbon black that is not-functionalized is in the range of 85 to 100 weight-%, preferably 90 to 100 weight-%, preferably 95 to 100 weight-%, more preferably 96 to 100 weight-%, even more preferably 97 to 100 weight-%, even more 98 to 100 weight-%.

Typically, the cation exchange capacity (CEC) of carbon black carbon is about 0.001 to 1 cmol/kg, preferably of about 0.005 to 0.75 cmol/kg, preferably 0.01 to 0.5 cmol/kg, preferably 0.01 to 0.25 cmol/kg, preferably 0.01 to 0.1 cmol/kg.

Typically, the density of the carbon black is in the range of 1 to 3 g/cc, preferably 1 to 2.5 g/cc, preferably 1.5 to 2 g/cc (particle density). Typically, the bulk density of the carbon black is in the range of 0.01 to 0.75 g/cc, preferably 0.05 to 0.5 g/cc, more preferably 0.1 to 0.25 g/cc.

Typically, the ash content of the carbon black composition is in the range of 0.001 to 5 weight-% of the composition, preferably 0.005 to 3 weight-%, even more preferably 0.01 to 2 weight-%, even more preferably 0.01 to 1 weight-%.

Typically, the specific surface area of the carbon black measured by Hg porosimetry (DIN66133) is in the range of 5 to 1500 m2/g, preferably 10 to 1000 m2/g, preferably 10 to 500 m2/g, preferably 10 to 250 m2/g, more preferably 10 to 200 m2/g, even more preferably 20 to 150 m2/g.

The carbon black is a hydrophobic material with a preferred contact angle of water droplets of greater than 90°, preferably greater than 100°, more preferably greater than 110°, more preferably greater than 120°, more preferably greater than 130°, more preferably greater than 140° as determined with the sessile droplet method (Bachmann, J. et al. (2000), Modified sessile drop method for assessing initial soil-water contact angle of sandy soil. Soil Science Society of America Journal 64, 564-567). The carbon black is a hydrophobic material with a preferred contact angle of water droplets in the range of ≥90° to ≤180°, preferably in the range of 100° to ≤180°, preferably in the range of 110° to 170°, more preferably in the range of 120° to 170°, even more preferably in the range of 130° to 170°, in particular in the range of 140° to 170°.

For example, plasma carbon black, liquid metal carbon black, catalytic carbon black and/or micro-wave carbon black as known in the art can be used as carbon black in this invention.

### Spreading of Pyrolytic Carbon:

The protective agents for macro- and megafauna could be spread or applied on the agricultural field (soil) in quantity ranging from 0.5 to 500 tons of pyrolytic carbon per ha, preferably 1 to 400 tons of pyrolytic carbon per ha, preferably 2 to 200 tons of pyrolytic carbon per ha, more preferably 10 to 60 tons of pyrolytic carbon per ha.

The soil protective agents for macro- and megafauna could be used in a range of 1 to 100 g pyrolytic carbon per kg soil, preferably 2 to 70 g pyrolytic carbon per kg soil, more preferably 5 to 60 g pyrolytic carbon per kg soil, even more preferably 10 to 40 g pyrolytic carbon per kg soil.

Preferably, the pyrolytic carbon is worked into the soil of at least 5 cm soil depth, even more preferably of at least 10 cm soil depth, even more preferably of at least 20 cm soil depth, even more preferably of at least 30 cm soil depth, even more preferably of at least 40 cm soil depth, even more preferably of at least 50 cm soil depth, even more preferably of at least 60 cm soil depth.

If granular pyrolytic carbon is used, the macro- and megafauna protective agent can be easily applied and worked into the soil. The macro- and megafauna protective agent can be deposited in a well-known spreader, e. g. fertilizer spreader, and pushed/pulled by hand or drawn by a tractor. Optionally the macro- and megafauna protective agent is worked into the topsoil layer with soil tillage equipment.

If carbon black is used, in one embodiment, carbon black can be used directly, as produced e.g., via the plasma process, with a primary particle size of preferably 1 nm to 1 μm, more preferred 5 to 500 nm more preferred 10 to 300 nm. In another embodiment, carbon black can be used as pellets with a particle size of preferably in the range of 0.3 to 15 mm, preferably 0.5 to 10 mm, more preferable 1 to 8 mm. Pelleting of carbon black is well known in the state of the art, typically, water can be used as binder.

Preferably, the pyrolytic carbon is worked in the topsoil homogeneously. The techniques to work pyrolytic carbon into the topsoil are known in the art, e. g. with soil tillage equipment.

Alternatively, the pyrolytic carbon is worked in the topsoil in rows, preferably in analogy to the crop/plant rows. Cultivation of plants in rows that have an even spacing of about 7-70 cm is well known, for example cereals, corn, sugar beets, sugarcane, cotton, rapeseed, potatoes or all horticultural crops that are lately planted in the field such as e.g., lettuce are grown in rows solely. This holds also true for permanent crops as fruit trees, tree plantations, and alike, which may be spaced from 50 cm up to 5 m in rows.

Optionally, the macro- and megafauna protective agent can be mixed with other commonly used soil conditioning substrates like fertilizer, liming material, commonly known soil improver, growing medium, inhibitor and/or plant bio-stimulant as regulated by the Regulations (EU) 2019/1009 and applied as a mixture. Optionally, the particle size of the macro- and megafauna protective agent can be adapted to the co-conditioning substrate, e. g. via classifying.

Optionally, the present macro- and megafauna protective agent can support different organic or inorganic additives, e. g. agrochemical active substance from the group of fungicides, bactericides, herbicides and/or plant growth regulators.

### Controlling the Presence of Earthworms

The present invention also provides a method for controlling the presence of earthworm which comprises applying hydrophobic pyrolytic carbon having a density of 1.6 to 2.3 g/cc, a carbon content of 95 to 100 weight-%, wherein 95 weight-% of the carbon is not-functionalized on that part of an area where presence of earthworm is desirable and leaving the other part of the area where the presence of earthworm is not desirable un-treated.

For example, pyrolytic carbon is applied on the rows where crops are for example cereals, corn, sugar beets, sugarcane, cotton, rapeseed, potatoes or all horticultural crops that are lately planted in the field such as e.g., lettuce and pyrolytic carbon is applied between the rows. For example, pyrolytic carbon is applied on the rows where permanent crops as fruit trees, tree plantations, and alike, grow and which may be spaced from 50 cm up to 5 m in rows.

Applied between the planting or seed rows of row crops the invention would increase water infiltration through the increased earthworm population (e.g., better soil aggregation, better macroporosity etc.).

For example, pyrolytic carbon is applied around a golf course, but not on the golf lawn area.

### Advantages:

It is evident that the stay of the earthworms was promoted over the entire concentration range of pyrolytic carbon or carbon black. This is remarkable against the background that earthworm populations are exposed to various threads from agricultural practice. This includes soil compaction, intensive tillage (Chan, 2001) one-sided crop rotations, as well as mineral (heavy metals as e.g., copper, Eijsackers et al., 2005) or pesticides as additives to soils (Pelosi et al., 2014; Gaupp-Berghausen et al., 2015). So, earthworms and earthworm services in cropping systems has potential to boost agricultural sustainability (Bertrand et al. 2015) and contribute substantially to yield and plant growth (van Groeningen et al., 2014) which is secured by addition of hydrophobic pyrolytic carbon. With respect to carbon black and effects on reproduction rate, however, an upper limit of application (33 g/kg soil) has to be taken into account, which could hardly be found for granular pyrolytic carbon.

### LITERATURE

“Chancen und Risiken des Einsatzes von Biokohle und anderer “veränderter” Biomasse als Bodenhilfsstoffe oder für die C-Sequestrierung in Böden”, Chapter 2.8 “Kurz-und langfristige Wirkungen der Biokohle im Boden, auf Bodenorganismen und Pflanzen”, Umweltbundeamt, 2016.
Muradov, N. (2017) Low to near-zero CO2 production of hydrogen from fossil fuels: Status and perspectives. International Journal of Hydrogen Energy 42.20, 14058-14088.
Bachmann, J. et al. (2000) Modified sessile drop method for assessing initial soil-water contact angle of sandy soil. Soil Science Society of America Journal 64, 564-567.
Bertrand, M. et al. (2015) Earthworm services for cropping systems. A review. Agron. Sustain. Dev. 35, 553-567.
Blume, H. P. (1992) Handbuch des Bodenschutzes. Bodenökologie und-belastung. Vorbeugende und abwehrende Schutzmaßnahmen. 2. Auflage-ecomed Verlag, Landsberg/Lech, 795 p
Chan K Y (2001) An overview of some tillage impacts on earthworm population abundance and diversity—implications for functioning in soils. Soil Tillage Res 57:179-191.
Eijsackers H, et al. (2005) The implications of copper fungicide usage in vineyards for earthworm activity and resulting sustainable soil quality. Ecotoxicol. Environ. Saf. 62, 99-111.
Gaupp-Berghausen, M. et al. (2015) Glyphosate-based herbicides reduce the activity and reproduction of earthworms and lead to increased soil nutrient concentrations. Scientific Reports DOI:10.1038/srep12886.
Hendrix, P. E. et al. (1990) Soil biota as components of sustainable agroecosystems. In: C. A. Edwards, R. Lal, P. Madden, R. H. Miller, C House (eds.) Sustainable agricultural systems. Ankeney, Iowa: Soil and Water Conservation Soc., 637-654.
Pelosi, C. et al. (2014) Pesticides and earthworms. A review. Agron. Sustain. Dev. 34, 199-228.
van Groeningen, J. et al. (2014) Earthworms increase plant production: a meta-analysis. Scientific Repots. DOI: 10.1038/srep06365

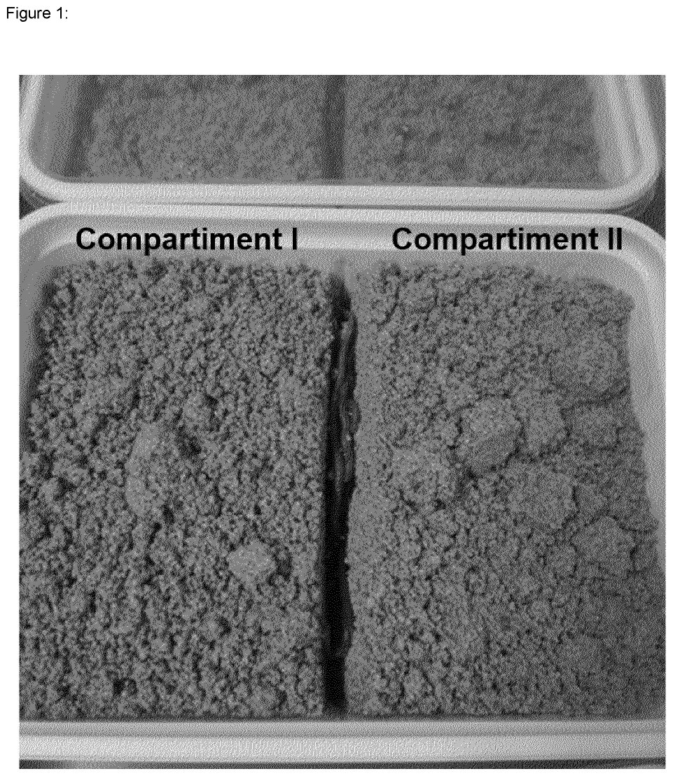

FIG. 1: Setup for avoidance test at start

### EXAMPLE

### 1 Characteristics

In the experiments, granular Pyrolytic Carbon and Carbon Black were tested:

TABLE 1a
Characteristic of the granular Pyrolytic Carbon and Carbon Black

| | granular | | Carbon Black | |
|---|---|---|---|---|
| | Pyrolytic | | (Cancarb Thermax N990 | |
| | Carbon | | ultra pure) | |
| Carbon content | 98 weight-% | | >95 weight-% | |
| Particle size | 1.5-2.0 | mm | 280 | nm |
| BET | <0.05 | m2/g | 10.3 | m2/g |
| Langmuir surface | 0.13 | m2/g | 15 | m2/g |
| Density | 1.98 | g/cc | 1.7-1.9 | g/cc |

| | | |
|---|---|---|
| Hydrophobicity: Contact | 109° ± 8° | 150° ± 3° |
| angle of water droplets | | |
| MED (analog | 4-5 | 5-6 |
| U.S. Pat. No. 9,809,502) | | |

The granular Pyrolytic Carbon was produced by decomposition of natural gas and deposition on calcined petroleum coke carrier material (having a particle size of 0.5-2.5 mm, a sulfur content of 1.1 weight-% and a real density in xylene of 2.09 g/cm3) in a fluidized bed at temperatures from 1100-1300° C. and at pressures from 1-2 bar (abs).

TABLE 1b
Characteristic of Biochar

| | Carbuna CPK 1-2 mm | |
|---|---|---|
| | (Biochar) | |
| Biochar | Made from wood | |
| Carbon content | 89.5 | wt.-% |
| Particle size | 1-2 | mm |
| Specific surface | 417 | m2/g |
| Bulk density | 339 | kg/m3 |

TABLE 1c
Effective cation exchange capacity

| | | Effective cation exchange |
|---|---|---|
| | | capacity (cmol⁺/kg), |
| | pH value | DIN EN ISO 11260: 2018 |
| Carbon Clack | 5.69 | 0.02 |
| (Cancarb Thermax | | |
| N990 ultra pure) | | |
| granular Pyrolytic | 6.87 | 0.10 |
| Carbon | | |
| Carbuna CPK 1-2 | 8.45 | 1.9 |
| mm (Biochar) | | |
| Soil <2 mm | 7.05 | 6.2 |

In the present study, a CEC of approximately 2 cmol/kg was determined for the biochar Carbuna CPK. The CEC of the pyrolytic carbon is in the range of 0.02 to 0.1 cmol/kg and a factor of lower than the CEC of the biochar.

BET: measured as described in DIN ISO 9277

Density: The specific weight (density) was determined by the Archimedes principle in pure water (see Wikipedia). Part of the experiments were done in water amended with a wetting agent to lower the surface tension of the water so that also hydrophobic particles may sink into the water if the specific weight is ≥1 g/cc.

Bulk Density: ASTM C559 “Standard test method for bulk density by physical measurement of manufactured carbon and graphite articles”

Hydrophobicity: Bachmann, J. et al. (2000) Modified sessile drop method for assessing initial soil-water contact angle of sandy soil. Soil Science Society of America Journal 64, 564-567

### 2 Earthworms Avoidance Test According to DIN ISO 17512-1

### Effect of Granular Pyrolytic Carbon and Carbon Black on Behavior of Earthworms

10 earthworms (Eisenia andrei) were placed on the border between the compartment I and compartment II (see FIG. 1) at the beginning of the experiment and their number in the compartments is counted 48 h later (if a worm was divided pressing the dividing disk in, it was counted with 0.5 for each compartment). An artificial soil according to OECD 222 (with 10% peat) was used were granular Pyrolytic Carbon or Carbon Black were incorporated or not prior to the placement of the earthworms.

Five replicates per treatment were done.

The results of the earthworm avoidance test are shown in Table 2; the numbers of earthworms are average values of five replicates. The avoidance (or attraction) behavior is thought to be caused by a modification of the ‘habitat function’ of the soil (i.e., its chemical quality). Table 2 shows that any addition of both Pyrolytic Carbon or Carbon Black increased the attractiveness of the soil treated in this way for the earthworms. The concentration series from 13.33 g/kg to 53.33 g/kg of soil (corresponding to about 10 to 40 t/ha for 5 cm soil depth) suggests that in the case of Pyrolytic Carbon the effect increases with increasing application rate somewhat, while in Carbon Black even the lowest tested application rate was sufficient for the strongest positive effect

A Residence factor could be calculated for the attractiveness of the carbon additives to the soil (Tab. 2). It indicates that the numbers of earthworms—if they have the choice—stayed at least 30% (maximum 80%) more in the treated soil than in the untreated control soil.

TABLE 2
Results of Earthworms Avoidance Test according to DIN ISO 17512-1 (ha calculations
for uniform incorporation of carbon into the soil for the layer 0-5 cm and a soil
density of 1.5 g/cm3). Average number of earthworms per section with five replicates
per treatment ± standard deviation. Residence factor (stay factor) calculated
as divided by 100 of the % in treated soil relative to no effect (n treated × 100/5).

| | | | Treated Soil | | |
|---|---|---|---|---|---|
| | | | | % earthworms | |
| | | | | in treated soil | |
| | | Control Soil | n earth- | relative to no | Residence- |
| | | n earthworms | worms | effect (5 worms) | Factor |
| Control (aqua bidest) | | 4.8 ± 1.30 | 5.2 ± 1.30 n.s. | 104 | 1.04 |
| Reference (boric acid | | 9.3 ± 0.84 | 0.7 ± 0.84 *** | 14 | 0.14 |
| 750 mg/kg) (toxic control) | | | | | |
| Pyrolytic | 13.33 g/kg | 3.2 ± 2.66 | 6.8 ± 2.66 + | 136 | 1.36 |
| Carbon | (10 t/ha (0-5 cm | | | | |
| | soil depth) | | | | |
| Pyrolytic | 33.33 g/kg | 3.4 ± 2.07 | 6.6 ± 2.07 * | 132 | 1.32 |
| Carbon | (25 t/ha, 0-5 cm | | | | |
| | soil depth) | | | | |
| Pyrolytic | 53.33 g/kg | 1.0 ± 0.71 | 9.0 ± 0.71 *** | 180 | 1.8 |
| Carbon | (40 t/ha (0-5 cm | | | | |
| | soil depth) | | | | |
| Carbon | 13.33 g/kg | 1.6 ± 1.52 | 8.4 ± 1.52 *** | 168 | 1.68 |
| Black | (10 t/ha (0-5 cm | | | | |
| | soil depth) | | | | |
| Carbon | 33.33 g/kg | 2.0 ± 1.58 | 8.0 ± 1.58 *** | 160 | 1.6 |
| Black | (25 t/ha, 0-5 cm | | | | |
| | soil depth | | | | |
| Carbon | 53.33 g/kg | 3.4 ± 2.30 | 6.6 ± 2.30 + | 132 | 1.32 |
| Black | (40 t/ha (0-5 cm | | | | |
| | soil depth) | | | | |

Difference of treated soil to control soil section: n.s. not significantly different from control;
different with
+ P < 0.1,
* P < 0.05,
*** P < 0.001

### 3 Determination of Effects on Reproduction Following ISO 11268-2

The test procedure followed ISO 11268-2 again with an artificial soil according to OECD 222. Application and application rates of both Pyrolytic Carbon and Carbon Black were the same as in the avoidance test. Four replicates per treatment and an untreated control with 8 replications were included. Since all carbon concentration levels for both Pyrolytic Carbon and Carbon Black are compared with the control without addition of carbon, their number of repetitions was set to n=8 in order to obtain well-validated results. To each container 10 worms (Eisenia andrei) were placed for the 56-day earthworm reproduction study.

The results of the earthworm reproduction test to ISO 11268-2 are shown in Table 3 for Pyrolytic Carbon and in Table 4 for Carbon Black (ha calculations for uniform incorporation of carbon into the soil for the layer 0-5 cm and a soil density of 1.5 g/cm3).

TABLE 3
Results of the earthworm reproduction test following ISO 11268-2
(Pyrolytic Carbon), numbers of juveniles after 56 days

| | | 13.33 g/kg | 33.33 g/kg | 53.33 g/kg |
|---|---|---|---|---|
| | | (10 t/ha) | (25 t/ha) | (40 t/ha) |
| | Control | Pyrolytic | Pyrolytic | Pyrolytic |
| replicates | (0 t/ha) | Carbon | Carbon | Carbon |
| 1 | 332 | 247 | 308 | 171 |
| 2 | 319 | 345 | 250 | 218 |
| 3 | 251 | 311 | 276 | 183 |
| 4 | 337 | 352 | 329 | 210 |
| 5 | 304 | | | |
| 6 | 294 | | | |
| 7 | 272 | | | |
| 8 | 343 | | | |
| Average (n) | 306.5 | 313.8 n.s. | 290.8 n.s. | 195.5*** |
| SD | 32.7 | 48.0 | 34.8 | 22.2 |
| Relative to | 100 | 102 | 95 | 64 |
| control | | | | |

SD: ±standard deviation; difference of treated soil to control: n.s. not significantly different from control;
different with
***P < 0.001

TABLE 4
Results of the earthworm reproduction test following ISO 11268-2
(Carbon Black), numbers of juveniles after 56 days.

| | | 13.33 g/kg | 33.33 g/kg | 53.33 g/kg |
|---|---|---|---|---|
| | Control | (10 t/ha) | (25 t/ha) | (40 t/ha) |
| replicates | (0 t/ha) | Carbon Black | Carbon Black | Carbon Black |
| 1 | 332 | 291 | 235 | 202 |
| 2 | 319 | 234 | 181 | 193 |
| 3 | 251 | 325 | 248 | 166 |
| 4 | 337 | 285 | 207 | 179 |
| 5 | 304 | | | |
| 6 | 294 | | | |
| 7 | 272 | | | |
| 8 | 343 | | | |
| Average (n) | 306.5 | 283.8 n.s. | 217.8** | 185.0*** |
| SD | 32.7 | 37.6 | 29.9 | 15.8 |
| Relative to | 100 | 93 | 71 | 60 |
| control | | | | |

SD: ±standard deviation; difference of treated soil to control: n.s. not significantly different from control;
different with
* P < 0.05,
**P < 0.01,
***P < 0.001

### 3.1 Granular Pyrolytic Carbon

In the reproduction study with Pyrolytic Carbon, no adverse effects on survival and biomass development could be determined at all concentrations tested up to and including 53.33 g Pyrolytic Carbon/kg dry soil as shown in Table 5.

TABLE 5
Granular Pyrolytic Carbon: Number of surviving
adult worms per replicate 4 weeks after test initiation
from a total of 10 worms per replicate.

| | | 13.33 g/kg | 33.33 g/kg | 53.33 g/kg |
|---|---|---|---|---|
| | | (10 t/ha) | (25 t/ha) | (40 t/ha) |
| | Control | Pyrolytic | Pyrolytic | Pyrolytic |
| replicates | (0 t/ha) | Carbon | Carbon | Carbon |
| 1 | 10 | 10 | 10 | 10 |
| 2 | 10 | 10 | 10 | 10 |
| 3 | 10 | 10 | 10 | 10 |
| 4 | 10 | 10 | 10 | 10 |
| 5 | 10 | | | |
| 6 | 10 | | | |
| 7 | 10 | | | |
| 8 | 10 | | | |
| Average | 10 | 10 | 10 | 10 |
| SD | 0 | 0 | 0 | 0 |
| Mortality (%) | 0 | 0 | 0 | 0 |

SD: ±standard deviation

The NOEC (no observed effect concentration) for mortality and biomass was determined to be ≥53.33 g Pyrolytic Carbon/kg dry soil weight, the highest concentration tested as shown in Table 6.

TABLE 6
Granular Pyrolytic Carbon: Biomass change (change in
fresh weight after 4 weeks relative to initial fresh
weight) weight per worm (mg) as mean per replicate.

| | | 13.33 g/kg | 33.33 g/kg | 53.33 g/kg |
|---|---|---|---|---|
| | | (10 t/ha) | (25 t/ha) | (40 t/ha) |
| | Control | Pyrolytic | Pyrolytic | Pyrolytic |
| replicates | (0 t/ha) | Carbon | Carbon | Carbon |
| 1 | 96.6 | 84.8 | 80.9 | 78.1 |
| 2 | 80.9 | 108.4 | 118.8 | 93.4 |
| 3 | 94.2 | 98.0 | 99.6 | 104.2 |
| 4 | 107.1 | 93.9 | 103.3 | 98.9 |
| 5 | 83.0 | | | |
| 6 | 121.6 | | | |
| 7 | 112.9 | | | |
| 8 | 121.4 | | | |
| Average | 102.2 | 96.3 n.s. | 100.7 n.s. | 93.7 n.s. |
| SD | 16.0 | 9.8 | 15.6 | 11.3 |

SD: ±standard deviation,
n.s. not significantly different from control

The NOEC for reproduction was determined to be 33.3 g/kg (Tab. 3)

TABLE 7
Summary of the results of the reproduction
study with Pyrolytic Carbon

| | g Pyrolytic Carbon/ |
|---|---|
| | kg dry soil |
| NOEC for mortality and biomass development | ≥53.33 |
| NOEC for reproduction | 33.3 |

### 3.2 Carbon Black

In the earthworm reproduction study with Carbon Black, no adverse effects on survival and biomass development could be determined at all concentrations tested up to and including 53.33 g Carbon Black/kg soil dry weight as shown in Table 8 and 9.

TABLE 8
Carbon Black: Number of surviving adult worms per replicate 4 weeks
after test initiation from a total of 10 worms per replicate.

| | | 13.33 g/kg | 33.33 g/kg | 53.33 g/kg |
|---|---|---|---|---|
| | | (10 t/ha) | (25 t/ha) | (40 t/ha) |
| | Control | Carbon | Carbon | Carbon |
| replicates | (0 t/ha) | Black | Black | Black |
| 1 | 10 | 10 | 10 | 10 |
| 2 | 10 | 10 | 10 | 10 |
| 3 | 10 | 10 | 10 | 10 |
| 4 | 10 | 10 | 10 | 10 |
| 5 | 10 | | | |
| 6 | 10 | | | |
| 7 | 10 | | | |
| 8 | 10 | | | |
| Average | 10 | 10 | 10 | 10 |
| SD | 0 | 0 | 0 | 0 |
| Mortality (%) | 0 | 0 | 0 | 0 |

SD: ±standard deviation

The NOEC for mortality and biomass was determined to be ≥53.33 g Carbon Black/kg soil dry weight, the highest concentration tested as shown in Table 8 and 9.

TABLE 9
Carbon Black: Biomass change (change in fresh weight
after 4 weeks relative to initial fresh weight)
weight per worm (mg) as mean per replicate.

| | | 13.33 g/kg | 33.33 g/kg | 53.33 g/kg |
|---|---|---|---|---|
| | Control | (10 t/ha) | (25 t/ha) | (40 t/ha) |
| replicates | (0 t/ha) | Carbon Black | Carbon Black | Carbon Black |
| 1 | 96.6 | 94.5 | 105.1 | 78.1 |
| 2 | 80.9 | 87.2 | 86.2 | 88.4 |
| 3 | 94.2 | 110.2 | 120.3 | 84.5 |
| 4 | 107.1 | 108.8 | 103.9 | 104.8 |
| 5 | 83.0 | | | |
| 6 | 121.6 | | | |
| 7 | 112.9 | | | |
| 8 | 121.4 | | | |
| Average | 102.2 | 100.2 n.s. | 103.9 n.s. | 89.0 n.s. |
| SD | 16.0 | 11.2 | 13.9 | 11.4 |

SD: ±standard deviation,
n.s. not significantly different from control

The NOEC for reproduction was determined to be 13.3 g/kg soil dry weight (Tab. 4).

TABLE 10
Summary of the results of the reproduction
study with Carbon Black

| | g Pyrolytic Carbon/ |
|---|---|
| | kg dry soil |
| NOEC for mortality and biomass development | ≥53.33 |
| NOEC for reproduction | 13.3 |

### 4. Combination of Reproduction Rate and Residence-Factor:

Since the avoidance test and the reproduction test were carried out in a standardized way under the same conditions (soil, temperature, etc.), it was possible to combine the results. Therefore, the reproduction rate of the individual repetitions was multiplied by the mean residence factors of the variants from Table 2 (see Table 11 and 12). This simulated the case that an area would be amended with Pyrolytic Carbon or Carbon Black next to an identical area without these soil additives. As can be seen for Pyrolytic Carbon, at all three dose rates the extrapolated reproduction rate exceeds with 134%, 120%, and 110% the 100% control, which was for 13.33 and 33.33 g/kg significantly higher (see Table 11 and 12).

For Carbon Black at the lower application the extrapolated reproduction rate was significantly increased, and a negative effect only observed at the highest application rate at 53.33 g/kg or about 40 t Carbon Black/ha in 0-5 cm (Tab. 12, last column).

TABLE 11
Results of multiplication of the reproduction rate per 10 worms
with the residence factors from Tab. 2 (Pyrolytic Carbon)

| | | 13.33 g/kg | 33.33 g/kg | 53.33 g/kg |
|---|---|---|---|---|
| | | (10 t/ha) | (25 t/ha) | (40 t/ha) |
| | Control | Pyrolytic | Pyrolytic | Pyrolytic |
| replicates | (0 t/ha) | Carbon | Carbon | Carbon |
| 1 | 345.3 | 335.9 | 406.6 | 307.8 |
| 2 | 331.8 | 469.2 | 330.0 | 392.4 |
| 3 | 261.0 | 423.0 | 364.3 | 329.4 |
| 4 | 350.5 | 478.7 | 434.3 | 378.0 |
| 5 | 316.2 | | | |
| 6 | 305.8 | | | |
| 7 | 282.9 | | | |
| 8 | 356.7 | | | |
| Average (n) | 318.8 | 426.7 ** | 383.79 * | 351.9 n.s. |
| SD | 34.0 | 65.2 | 46.0 | 39.9 |
| Relative to | 100 | 134 | 120 | 110 |
| control | | | | |

SD: ±standard deviation, difference of treated soil to control: n.s. not significantly different from control;
different with
* P < 0.05,
** P < 0.01.

TABLE 12
Results of multiplication of the reproduction rate per 10
worms with the residence factors from Tab. 2 (Carbon Black)

| | | 13.33 g/kg | 33.33 g/kg | 53.33 g/kg |
|---|---|---|---|---|
| | Control | (10 t/ha) | (25 t/ha) | (40 t/ha) |
| replicates | (0 t/ha) | Carbon Black | Carbon Black | Carbon Black |
| 1 | 345.3 | 488.9 | 376.0 | 266.6 |
| 2 | 331.8 | 393.1 | 289.6 | 254.8 |
| 3 | 261.0 | 546.0 | 396.8 | 219.1 |
| 4 | 350.5 | 478.8 | 331.2 | 236.3 |
| 5 | 316.2 | | | |
| 6 | 305.8 | | | |
| 7 | 282.9 | | | |
| 8 | 356.7 | | | |
| Average (n) | 318.8 | 476.7 *** | 348.4 n.s. | 244.2 ** |
| SD | 34.0 | 63.1 | 47.8 | 20.9 |
| Relative to | 100 | 148 | 108 | 76 |
| control | | | | |

SD: ±standard deviation, difference of treated soil to control: n.s. not significantly different from control;
different with
* P < 0.05,
** P < 0.01,
*** P < 0.001.

1.-15. (canceled)

16. A protective agent for macro- and megafauna containing a hydrophobic pyrolytic carbon composition having a density of 1 to 3 g/cc, a carbon content of 95 to 100 weight-% and an ash content of 0.001 to 5 weight-%, wherein 85 weight-% of the carbon is not-functionalized and wherein the cation exchange capacity of the pyrolytic carbon is 0.001 to 0.75 cmol/kg.

17. The protective agent according to claim 16, wherein the carbon content is of 98 to 100 weight-%.

18. The protective agent according to claim 16, wherein the pyrolytic carbon is a hydrophobic material with a contact angle of water droplets of greater than 100°.

19. The protective agent according to claim 16, wherein 90 weight-% of the carbon is not-functionalized.

20. The protective agent according to claim 16, wherein the density is of 1 to 2.5 g/cc.

21. The protective agent according to claim 16, wherein the ash content is of 0.001 to 2 weight-%.

22. The protective agent according to claim 16, wherein the specific surface area of the pyrolytic carbon measured by Hg porosimetry (DIN66133) is in the range of 0.001 to 150 m2/g.

23. The protective agent according to claim 16, wherein the agent supports agrochemical active substance from the group of fungicides, bactericides, herbicides and/or plant growth regulators.

24. The protective agent according to claim 16, wherein the protective agent for macro- and megafauna is a protective agent for earthworms.

25. A method to protect soil macro- and megafauna on agricultural fields which comprises applying hydrophobic pyrolytic carbon composition on the agricultural fields, wherein the pyrolytic carbon has a density of 1 to 3 g/cc, a carbon content of 95 to 100 weight-% and an ash content of 0.001 to 5 weight-%, wherein 85 weight-% of the carbon is not-functionalized and wherein the cation exchange capacity of the pyrolytic carbon is 0.001 to 0.75 cmol/kg.

26. The method according to claim 25, wherein the pyrolytic carbon composition is spread on the agricultural fields in quantity ranging from 0.5 to 500 tons per ha and the pyrolytic carbon composition is worked into the soil of at least 30 cm soil depth.

27. The method according to claim 25, wherein pyrolytic carbon composition is worked in the topsoil in rows, in analogy to the crop or plant rows.

28. Use of hydrophobic pyrolytic carbon composition having a density of 1 to 3 g/cc, a carbon content of 95 to 100 weight-% and an ash content of 0.001 to 5 weight-%, wherein 85 weight-% of the carbon is not-functionalized and wherein the cation exchange capacity of the pyrolytic carbon is 0.001 to 0.75 cmol/kg as protective agent for agricultural fields and/or gardening.

29. A method for controlling the presence of earthworms comprising applying hydrophobic pyrolytic carbon composition having a density of 1 to 3 g/cc, a carbon content of 95 to 100 weight-% and an ash content of 0.001 to 5 weight-%, wherein 85 weight-% of the carbon is not-functionalized, on a part of an area where presence of earthworms is desirable and leaving the other part of the area where the presence of earthworms is not desirable un-treated.
